(19) United States
(12) Patent Application Publication
(10) Pub. No.: US 2005/0047729 A1
(43) Pub. Date: Mar. 3, 2005

(54) Optical transmission system and surface mount LED module for use therewith

(76) Inventor: Anthony W. Vilgiate, Murietta, CA (US)

Correspondence Address: Harold L. Jackson;Jackson Law Corporation, Ste. N, 14751 Plaza Dr., Tustin, CA, 92780, US

(21) Appl. No.: 10/652,172

(22) Filed: Aug. 29, 2003

(51) Int. Cl. G02B 6/36

(52) U.S. Cl. 385/92

(57) ABSTRACT

An optical transmission system couples light from a surface mount LED module, secured to a printed circuit board, to a lens unit on a remotely located panel via a light pipe. The surface mount LED module includes a cylindrical housing with a flat bottom surface, adaptable to be mounted on the board's surface, and a blind bore for receiving one end of the light pipe. An LED chip set, comprised of one or more individual LEDs, is positioned in the housing at the base of the blind bore with leads having one end thereof connected to respective LED electrodes, the other ends extending outside of the housing for connection to conductive pads on the board.

### FIELD OF THE INVENTION

The present invention relates to optical transmission systems for coupling light from light emitting diodes located on printed circuit boards to a remote location and to a surface mount LED module for use with such system

### DESCRIPTION OF THE PRIOR ART

Light emitting diodes (LEDs) or other such light sources provide visual information for many applications. Typically LEDs are mounted on printed circuit boards along with other electronic components such as resistors, capacitors, transistors, inductors, semiconductor chips, which, at least in part, function to turn on and off the LEDs at the appropriate times. In order to view the output of the LED, its light providing information may be transferred along a light pipe and displayed at a display site location such as on a panel. Many prior art arrangements have evolved over the years in an attempt to provide light source monitoring.

See, for example, U.S. Pat. Nos. 3,532,873; 4,826,273; 5,938,324; 5,818,995; and 5,548,676. In addition see U.S. Pat. No. 6,302,595 (“'595 patent”) assigned to the assignee of this application.

The '595 patent discloses an optical transmission system in which light is coupled to a lens mounted on a panel via a light pipe from an LED on a printed circuit board. The light receiving end of the pipe is coupled to a board mounted LED via a fitting base positioned over the LED and secured to the board via pegs extending therethrough. Alternatively, the fitting base may house the LED with energizing leads extending through the board for connection with conductive tracings on the underside of the board. While the '595 invention has been satisfactorily received by the industry, there is a need for a less expensive LED housing which is attachable to a circuit board in a simpler manner.

### SUMMARY OF THE INVENTION

A surface mount LED module for coupling the emitted light to the light receiving end of a light pipe comprises a housing having a substantially flat bottom surface and a wall surrounding a blind bore sized to receive the light pipe. Preferably the wall extends upwardly from the housing bottom and is cylindrical in shape. At least one LED is mounted in the housing in light communication with the blind bore. The housing includes a plurality of conductors mounted therein with a first end of the conductors connected to respective electrodes of said at least one LED. The second end of the conductors are located outside of the housing in a plane substantially parallel to the housing's bottom surface, enabling the housing bottom to be positioned on the exterior surface of the circuit board with the second ends of the conductors connected to electrically conductive pads accessible on the board surface.

The present invention also includes an elongated light pipe having a light entrace end disposed in the blind bore of the LED module and a light exit end secured to a remotely located lens unit.

The construction and operation of a preferred embodiment of the present invention may best be understood by reference to the following description taken in conjunction with the accompanying drawings.

### BRIEF DESCRIPTION OF THE DRAWINGS

FIG. 1 is a side elevational view of an optical system in accordance with the present invention which incorporates a surface mount LED and printed circuit board assembled with a display panel;

FIG. 2 is a perspective view of the surface mount LED module;

FIG. 3 is a top plan view of the LED module;

FIG. 4 is a cross-sectional view of the LED module illustrating the blind bore for receiving the light entrance end of a light pipe;

FIG. 5 is a top plan view of an LED chip set and a two conductor lead frame disposed within a die prior to molding the housing around the chip and the conductor;

FIG. 6 is a top plan view of alternative conductive lead frame with four leads and a chip set disposed within a die prior to molding the housing; and

FIG. 7 is a top plan view of the completed housing sitting on four conductive pads as they might be configured on a circuit board.

### DESCRIPTION OF THE PREFERRED EMBODIMENT

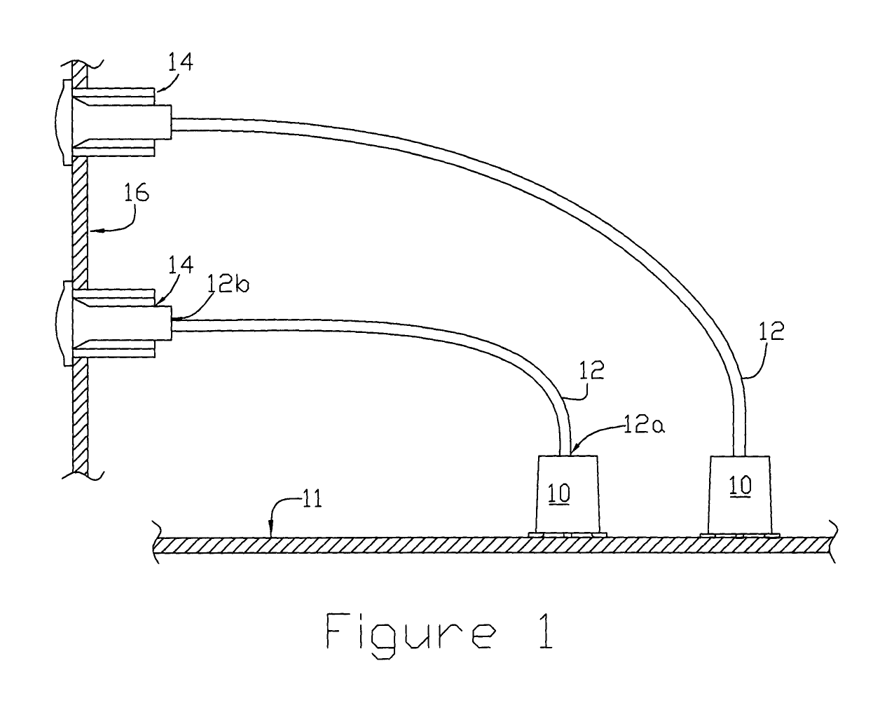

Referring now to the drawings and particularly to FIG. 1 there is shown an optical transmission system for providing optical coupling of light from a pair of surface mount LED modules 10 located on a circuit board 11 via light pipes 12 to lens units 14 positioned on a remotely located panel 16. The construction of such lens units and the light pipe is described in the '595 patent which description and illustrations thereof are incorporated herein by reference. The light pipes have light entrance and exit ends 12a and 12b, respectively.

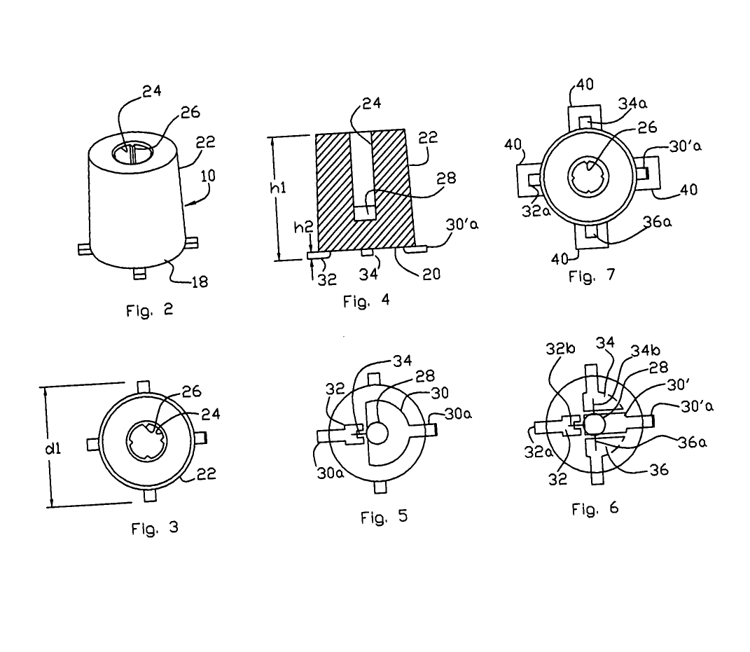

Referring now to FIGS. 2-6 the surface mount LED module is in the form of an injection molded housing having a substantially flat bottom surface 20 (FIG. 4) and a peripheral wall 22 surrounding a blind bore 24. Radially inwardly extending ridges 26 aid in securing the light entrance end of the light pipe within the bore. It should be noted, however, that in lieu of the ridges an interference fit between a smooth bore and the outer periphery of the light pipe will also suffice to secure the two components together.

An LED chip 28, which may include one or more individual LEDs, is positioned at the bottom of the blind bore to transmit emitted light to the light entrance end 12a of the light pipe 12.

The conductive leads for providing energizing current to the LED or LEDs in a chip set are shown in FIGS. 5 and 6, as such leads exist in a die prior to the injection molding step. FIG. 5 illustrates the leads for a single LED in which one of the LED electrodes, normally the anode, is bonded directly to a plate conductor 30, a portion 30a thereof extending beyond the die periphery. The other electrode is coupled to another conductor plate 32 via a thin wire 32b. The term “first end of a conductor connected to a respective electrode of an LED” as used herein includes the portion of the plate 30 bonded to one of the LED electrodes or to the end of the wire 32b bonded to the other electrode. The second end of the conductor as used herein includes the plates portions 30a and 32a which extend beyond the periphery of the housing.

FIG. 6 illustrates a four plate conductor insert with plate 30′ being bonded to a common electrode of three LEDs within the chip set 28. The other electrodes are connected to plates 32, 34 and 36 via wires 32b, 36b and 38b, respectively. The second end at the plates, i.e., 30′a, 32a, 34a, and 36a extend outwardly of the perimeter in the finished housing as is illustrated in FIGS. 4 and 7. While the conducting plates shown in FIG. 6 accommodate three LEDs, e.g, red, blue and green, it is apparent that only one or two LEDs many be used with the conducting plate arrangement or assembly of FIG. 6 since the unused plates will remain electrically isolated. It is to be noted that the individual LEDs may have a diameter of 0.010″ or less with the chip set dimensioned accordingly.

Once the mold insert, i.e., the chip set 28, conducting plates 30-36, and associated wires are placed in a die (not shown) a suitable plastic, such as polycarbonate, may be injected into the die under high pressure (i.e., insert molding) in a well known manner to form the completed LED module 10.

FIG. 7 illustrates a completed LED module positioned on conducting pads 40 as such pads would be located on the surface of a printed circuit board.

By way of example, the housing may have a height h₁ of about 0.300″ or 7.6 mm including the protruding conducting plates and a diameter d₁ including the protruding plates of the same dimension with the height h₂ of the protruding plates measuring about 0.016″ or 4 mm.

There has thus been described a novel optical transmission system and surface mount LED module for use therewith. Large quantities of the LED modules and lens unit can be readily manufactured at low costs thereby enabling demands from large customers to be quickly and reliably met. Light pipes can be cut to size at an installation site. Various modifications of the surface mount LED module and system will occur to persons skilled in the art without involving any departure from the spirit and scope of the invention as set forth in the appended claims.

1. In an optical transmission system for coupling light from a printed circuit board to a remote location via a light pipe, the improvement of a surface mount LED module comprising:
a housing having a substantially flat bottom surface and a wall surrounding a blind bore sized to received one end of the light pipe;
at least one LED mounted in the housing in light communication with the blind bore;
at least two conductors mounted in the housing with a first end of each conductor connected to a respective electrode of said one LED; and
the second end of each of the conductors being located outside of the housing in a plane substantially parallel to the bottom, whereby the housing base may be positioned on the surface of a circuit board and the second end of the conductors electrically connected to conductive pads accessible on the circuit board surface.

2. The LED module of claim 1 wherein the wall extends upwardly from the housing bottom.

3. The LED module of claim 2 wherein the second end of each of the conductors extend radially outwardly from the housing.

4. The LED module of claim 3 wherein said one LED comprises a plurality of LEDs and said at least two conductors comprises n+1 conductors where n equals the number of LEDs, the first end of the conductors being connected to the appropriate electrodes of the LEDs so that current can be applied separately to each LED.

5. The LED module of claim 4 wherein the housing is cylindrical.

6. The LED module of claim 5 wherein said plurality of LEDs is two.

7. The LED module of claim 6 wherein said plurality of LEDs is three.

8. The LED module of claim 5 wherein each of said conductors includes a conductive plate extending outwardly from the housing adjacent the bottom thereof.

9. The LED module of claim 8 wherein the housing is formed of an injection molded polycarbonate.

10. An optical system for coupling light from a printed circuit board to a remote panel having an opening through which light is to be transmitted, the circuit board having conductive pads on a surface thereof for providing current to one or more LEDs comprising:
an elongated flexible light pipe having a light entrance and a light exit end;
a lens unit positioned in the panel opening and coupled to the light exit end of the light pipe; and
a surface mount LED module having a housing with a substantially flat bottom surface and a peripheral wall extending upwardly from the bottom and surrounding a blind bore, the light entrance end of the light pipe being secured within the blind bore, the module including one or more LEDs mounted in the housing in light communication with the light entrance end of the light pipe, and conductive leads with one end of the leads connected to respective electrodes of the one or more LEDs, the other ends of the leads extending outwardly from the housing adjacent the bottom thereof and bonded to the board's conductive pads.

11. The optical system of claim 10 wherein three LEDs are mounted in the housing.

12. The optical system of claim 11 wherein said other ends of the leads extend below the housing's bottom surface.

13. The optical system of claim 12 wherein the housing is cylindrical.

14. The optical system of claim 13 wherein the housing is formed of an injection molded polycarbonate.

15. A surface mount LED module for transmitting light to the light entrance end of light pipe comprising:
a cylindrical housing formed of a plastic and having a substantially flat bottom surface and an upstanding peripheral wall surrounding a blind bore sized to receive the light entrance end of the light pipe;
a plate assembly comprised of a plurality of individual conducting plates, a first portion of the plates being secured within the housing and below the blind bore and a second portion of the plates being located outside of the housing adjacent the housing bottom surface;
an LED chip set comprising a plurality of LEDs mounted within the housing so that light from an energized LED will be transmitted to the light entrance end of a light pipe positioned within the blind bore; and
a common electrode of the LEDs being connected to one of the plates, the other electrode of the LEDs being individually connected to the other conductive plates whereby current may be supplied to selected LEDs via the plate assembly.
